(19) United States
(12) Patent Application Publication
(10) Pub. No.: US 2012/0000216 A1
(43) Pub. Date: Jan. 5, 2012

(54) ICE MAKER OF REFRIGERATOR AND POWER SAVING METHOD OF ICE MAKER

(76) Inventors: Seongjae KIM, Seoul (KR); Hoyoun Lee, Seoul (KR)

(21) Appl. No.: 13/175,729

(22) Filed: Jul. 1, 2011

(30) Foreign Application Priority Data
Jul. 1, 2010 (KR) 10-2010-0063618

(51) Int. Cl. F25C 1/00; G05D 23/32; F25B 49/00; F25C 5/18

(52) U.S. Cl. 62/66; 62/344; 62/125; 62/157; 62/132

(57) ABSTRACT

An ice maker for a refrigerator and a power saving method of an ice maker are provided. The ice maker includes: an ice tray for making ice; an ejector for removing the ice from the ice tray; an storage unit for dispensing and storing the removed ice; and a controller for controlling an ice making operation for making ice, an ice removing operation for removing generated ice, and a dispensing operation of dispensing removed ice, and providing control to cut off power supply during the ice making operation. While an ice making operation is being performed, an ice making elapsed-time and an ice making temperature are measured to determine whether or not the ice making operation has been completed, and while the ice making operation is being performed, power supplied to the ice maker is cut off, thus reducing unnecessary power consumption.

### CROSS-REFERENCE TO RELATED APPLICATION

Pursuant to 35 U.S.C. §119(a), this application claims the benefit of earlier filing date and right of priority to KR Application No. 2010-0063618, filed on Jul. 1, 2010, the contents of which is incorporated by reference herein in its entirety.

### 1. FIELD OF THE INVENTION

The present invention relates to an ice maker for a refrigerator and a method for saving power of the ice maker and, more particularly, to an ice maker for a refrigerator capable of reducing power consumption by controlling power supply, and a power saving method of the ice maker.

### 2. DESCRIPTION OF THE RELATED ART

In general, a refrigerator is a device for refrigerating and freezing food items so as to be freshly kept in storage.

The refrigerator includes a refrigerator main body in which a refrigerating chamber and a cooling chamber are demarcated by a partition wall, a refrigerating cycle device for providing cold air0 to the cooling chamber, and doors rotatably mounted to the main body and opening and closing the refrigerating chamber and the cooling chamber, respectively.

An ice maker is a device for making ice with water supplied from the exterior. Such an ice maker is mounted at an inner side of the refrigerating chamber or freezing chamber door to make ice upon providing cold air having a certain temperature or lower from the cooling chamber. The ice thusly made is dispensed to the exterior through a dispenser installed on the refrigerating chamber door, without opening the door.

The operation of the ice maker may be divided into an ice making step in which supplied water is frozen, and follow-up steps such as ice-full state, removing ice, dispensing, water supplying after the ice making step. In such an ice maker in the prior art is continuously provided with power from a power supply unit while the ice making step and the follow-up steps are performed. Namely, the ice maker is constantly actuated unless it is forcibly stopped by a user.

However, the ice making step is performed for a considerably long period of time, and in this step, the ice maker is in a standby state, rather than substantially operating.

Thus, since power is continuously supplied to the ice maker even in the standby state, resulting in a waste of power consumption.

### SUMMARY OF THE INVENTION

An aspect of the present invention provides an ice maker for a refrigerator capable of reducing unnecessary power consumption by cutting off power supplied to the ice maker while ice is being made, and a power saving method of the ice maker.

Another aspect of the present invention provides an ice maker for a refrigerator capable of effectively supplying power to the ice maker by cutting off power supply to the ice maker during at least a minimum time required for performing ice making step and determining whether to resupply power upon determination whether or not an ice making temperature is satisfied when the minimum time has lapsed, and a power saving method of the ice maker.

According to an aspect of the present invention, there is provided an ice maker for a refrigerator. The ice maker for a refrigerator, includes an ice tray for making ice; an ejector for removing ice made in the ice tray; a storage unit for dispensing and storing the removed ice; and a controller for controlling an ice making operation for making ice, an ice removing operation for removing the ice from the ice tray, and a dispensing operation of dispensing the removed ice, and providing control to cut off power supply during the ice making operation.

The ice maker may further include: a timer for measuring the lapsed-time starting from a point in time at which the ice making operation is initiated.

The ice maker may further include: a temperature sensor unit for sensing the temperature of the ice tray while the ice making operation is performed.

The ice maker may further include: a first comparator for comparing the elapsed-time measured by the timer with a reference ice making time in order to determine whether or not the ice making operation has been completed.

The ice maker may further include: a second comparator for comparing the temperature sensed by the temperature sensor unit with a reference ice making temperature in order to determine whether or not the ice making operation has been completed.

The ice maker may further include: an ice making operation switch for generating an initial signal of the ice making operation.

When the measured elapsed-time is equal to or greater than the reference ice making time according to the comparison results from the first comparator, the controller may determine that the ice making operation has been completed, and release the cutoff of the power supply.

When the sensed temperature satisfies the reference ice making temperature according to the comparison results from the second comparator, the controller may determine that the ice making operation has been completed, and release the cutoff of the power supply.

The ice maker may further include: a display unit for displaying whether or not the ice making operation is performed.

The ice maker may further include: a memory for storing one or more of the measured elapsed-time, the sensed temperature, an error range with the reference ice making time/the reference ice making temperature, the comparison results from the first and second comparators, history information regarding the ice making operation, the ice removing operation, the dispensing operation during a certain period of time.

According to another aspect of the present invention, there is provided a power saving method of an ice maker for a refrigerator including an ice making operation for making ice, an ice removing operation for removing the ice from an ice tray, and a dispensing operation for dispensing the removed ice, the method includes: determining whether or not the ice making operation is being performed; and when it is determined that the ice making operation is being performed, cutting off power supply to the ice maker.

The determining whether or not the ice making operation is being performed may include: measuring elapsed-time starting from a point in time at which the ice making operation is initiated; comparing the measured elapsed-time with a reference ice making time; and determining whether or not the ice making operation has been completed according to the comparison results.

The determining whether or not the ice making operation is being performed may include: sensing the temperature of an ice tray while the ice making operation is being performed; comparing the sensed temperature with a reference ice making temperature; and determining whether or not the ice making operation has been completed according to the comparison results.

In determining whether or not the ice making operation has been completed, when the measured elapsed-time is equal to or greater than the reference ice making time, it may be determined that the ice making operation has been completed, and when the measured elapsed-time is smaller than the reference ice making time, it may be determined that the ice making operation is being performed.

In determining whether or not the ice making operation has been completed, when the sensed temperature satisfies the reference ice making temperature, it may be determined that the ice making operation has been completed, and when the sensed temperature does not satisfy the reference ice making temperature, it may be determined that the ice making operation is being performed.

In determining whether or not the ice making operation has been completed, when the measured elapsed-time is equal to or greater than the reference ice making time and the sensed temperature satisfies the reference ice making temperature, it may be determined that the ice making operation has been completed, or otherwise, it may be determined that the ice making operation is being performed.

The method may further include: when it is determined that the ice making operation has been completed, releasing the cutoff of power supply and supplying power to the ice maker.

The method may further include: generating a signal in order to inform about an initiation of the ice making operation.

The method may further include: storing/recording one or more of the measured elapsed-time, the sensed temperature, an error range with the reference ice making time/the reference ice making temperature, the comparison results in the comparing step, history information regarding the ice making operation, the ice removing operation, the dispensing operation during a certain period of time.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flow chart illustrating the process of a general ice maker;

FIG. 2 is a schematic block diagram of an ice maker according to an embodiment of the present invention;

FIGS. 3 and 4 are a flow chart illustrating a power saving method of an ice maker and a time chart according to a first embodiment of the present invention;

FIGS. 5 and 6 are a flow chart illustrating a power saving method of an ice maker and a time chart according to a second embodiment of the present invention; and

FIGS. 7 and 8 are a flow chart illustrating a power saving method of an ice maker and a time chart according to a third embodiment of the present invention.

### DETAILED DESCRIPTION OF THE INVENTION

Hereinafter, exemplary embodiments will be described in detail with reference to the accompanying drawings but the present disclosure is not limited by the embodiments hereinafter.

The terms and words used in the present specification and claims should not be interpreted as being limited to typical meanings or dictionary definitions, but should be construed as having meanings and concepts relevant to the technical scope of the present invention based on the rule according to which an inventor can appropriately define the concept of the term to describe most appropriately the best method he or she knows for carrying out the invention.

An ice maker for a refrigerator and a power saving method of an ice maker will be described with reference to the accompanying drawings.

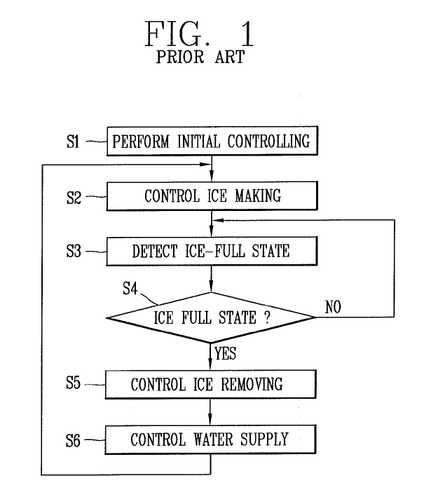

FIG. 1 is a flow chart illustrating the process of a general ice maker.

The general ice maker includes an ice tray storing water supplied from the exterior and making ice therein, an ejector for separating the ice from the ice tray, an storage unit positioned below the ice tray and storing the removed ice, a water supply device for supplying water to the ice tray, a controller for controlling operations of the plurality of units or devices, and a power supply unit supplying power to the controller.

The general ice maker operates as follows. First, the power supply unit supplies power to ice maker to perform initial control, at step S1. When an electrical signal for initiating the ice making operation through an external switch is received, the controller supplies water to the ice tray through the water supply device. When the water supply step is completed, water supplied to the ice tray is exposed to cold air provided from a cooling chamber for a certain period of time to make ice, at step S2. Thereafter, at step S3, it is sensed by an ice-full state sensor installed in the ice maker whether or not ice making has been completed. When it is determined that ice is full in step S4, the controller separates the generated ice from the ice tray by using an ejector, and dispenses the ice to the storage unit through a dispensing device or the like, at step S5. When ice is dispensed, the controller controls the water supply device in order to perform the ice making operation, at step S6.

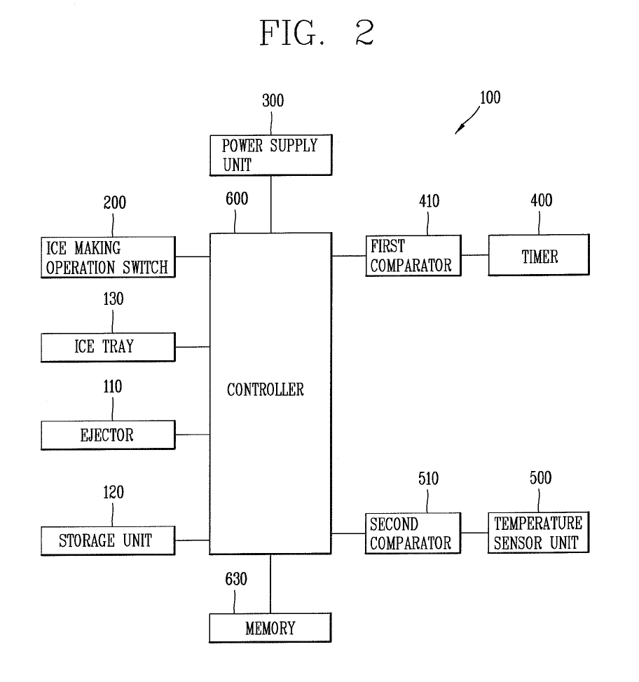

FIG. 2 is a schematic block diagram of an ice maker according to an embodiment of the present invention.

As illustrated in FIG. 2, an ice maker 100 is installed in a refrigerator (not shown) including a cooling chamber and a refrigerating chamber which are demarcated in the refrigerator, or at an inner side of a door of the refrigerating chamber or a freezing chamber. When the ice maker 100 is mounted at an inner side of the door of the refrigerating chamber, cold air of the cooling chamber is provided to the ice maker 100 through a duct connecting the cooling chamber and the refrigerating chamber.

The ice maker 100 includes an ice tray 130 providing a certain amount of water and making ice therein, an ejector 110 removing the ice from the ice tray 130, a storage unit 120 storing the removed ice, an ice making operation switch 200 generating an initial signal of the ice making operation, and a controller 600 controlling the ice making operation, the ice removing operation, a dispensing operation, and an operation regarding whether to cut off power supply to the ice maker 100.

Also, the ice maker 100 further includes a timer 400 measuring a elapsed-time in which the ice making operation is performed, a temperature sensor unit 500 sensing an ice making temperature of the ice tray, a first comparator 410 comparing a elapsed-time measured by the timer with a reference ice making time, a second comparator 510 comparing the temperature sensed by the temperature sensor unit 500 with a reference ice making temperature, and a power supply unit 300 supplying power to the ice maker 100. The ice maker 100 may further include a display unit (not shown). The display unit may display various types of information to allow a user to recognize whether or not power supply has been cut off, a current operation state of the ice maker 100, or the like. The display unit may be configured as a display device using a flat panel such as an LCD or a PDP, or may be configured as a device generating an audible signal.

A schematic operation of the ice maker 100 is described as follows. A certain amount of water is supplied to the ice tray 130. The supplied water is exposed to cold air provided from the cooling chamber so as to be frozen (ice making step). When the ice making step is completed and a ice-full state is detected, an ejector 110 separates the ice from the ice tray 130 (ice removing step). The ice removing operation may be performed by applying physical force to the ice in the ice-full state, by downwardly rotating the ice tray 130 through a motor, or the like, or twisting the ice tray 130. The removed ice is dispensed to and stored in the ice storage unit 120 positioned below the ice maker 100. Through such sequential processes are performed, a certain amount of water is supplied again to the ice tray 130, and each step is performed recurrently.

The operation of a power saving method of the ice maker according to an embodiment of the present invention will now be described.

The ice maker 100 is electrically connected with the power supply unit 300 and operates upon receiving power from the power supply unit 300. An electrical signal indicating an initiation of an ice making step is transmitted to the controller 600 of the ice maker 100 by the ice making operation switch 200. Upon receiving the electrical signal, the controller 600 may recognize the initiation of the ice making step. When the initiation of the ice making step is checked, the controller 600 cuts off power supply from the power supply unit 300 through such as a breaker, or the like. In this case, the breaker may be implemented to selectively connect or cut off power supplied from the power supply unit 300 to the ice maker 100. The cutoff of the power supply continues while the ice making step of the ice maker 100 is performed, and stops when the ice making step is completed. In order to determine whether or not the ice making step has been completed, the lapse of a certain time up to now starting from a point in time at which the ice making step was initiated may be measured each time or intermittently by the timer 400 of the ice maker 100. The measured elapsed-time is compared with a reference ice making time. In this case, the reference ice making time refers to a minimum ice making time required for making time. Also, in order to determine whether or not the ice making step has been completed, a current temperature since the point in time at which the ice making step was initiated may be sensed each time or intermittently by the temperature sensor unit 500 of the ice maker 100. The sensed temperature is compared with a reference ice making temperature. In this case, the reference ice making temperature refers to the lowest ice making temperature at which ice is made. The reference ice making temperature may have a particular temperature value or may have a certain temperature range in which ice is made. Also, the reference ice making time and the reference ice making temperature may be obtained through experimentation, may be pre-set values through a numerical value interpretation, or may be values which have been changed based on the amount of water supply, the number of times of water supply, an internal temperature of the refrigerator, or the like. The controller 600 receives an elapsed-time value measured by the timer 400, in real time, and uses it to determine whether or not the ice making step has been completed. Also, the controller 600 receives a temperature value sensed by the temperature sensor unit 500, in real time, and uses it to determine whether or not the ice making step has been completed. Namely, when the measured elapsed-time is smaller than the reference ice making time, the controller 600 determines that the ice making step has not been completed, and maintains the cutoff of power supply. And, the controller 600 continuously performs the ice making operation. Similarly, when the sensed temperature does not satisfy the reference ice making temperature, the controller 600 determines that the ice making step has not been completed and maintains the cutoff of power supply. And the controller continuously performs the ice making operation. In this case, in order to determine whether or not the ice making step has been completed, the controller 600 may use only the ice making time, only ice making temperature, or both the ice making time and the ice making temperature. History information such as the operations before initiating the ice making operation, the initial signal of the ice making operation, the measured elapsed-time, the sensed temperature, comparison results with the reference ice making time and the reference ice making temperature, and the like, may be stored in the memory 630. When the measured elapsed-time is equal to or greater than the reference ice making time and/or the sensed temperature satisfies the reference ice making temperature, the controller 600 determines that the ice making step has been completed. Then, the controller 600 releases the cutoff of power supply through such as an operation of the switch 200, or the like, and resumes supplying power to the ice maker 100. When the ice making step is completed and an ice-full state is detected, the foregoing operations such as ice removing, dispensing, or the like, are performed. In this manner, since unnecessary power supply is cut off while the ice making step of the ice maker 100 is performed, a waste of power which is consumed for a long period of time can be prevented.

A power saving method when the ice maker 100 operates according to embodiments of the present invention will now be described in detail.

### First Embodiment

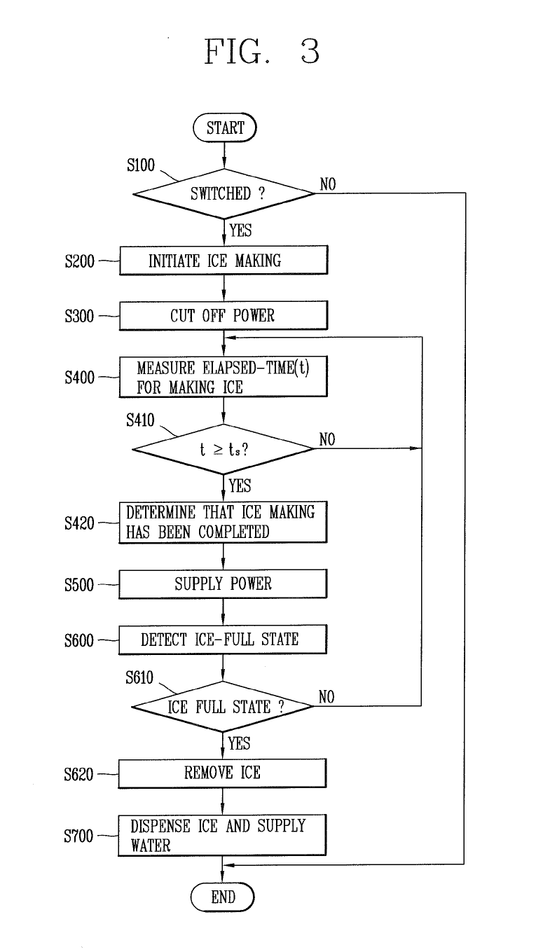

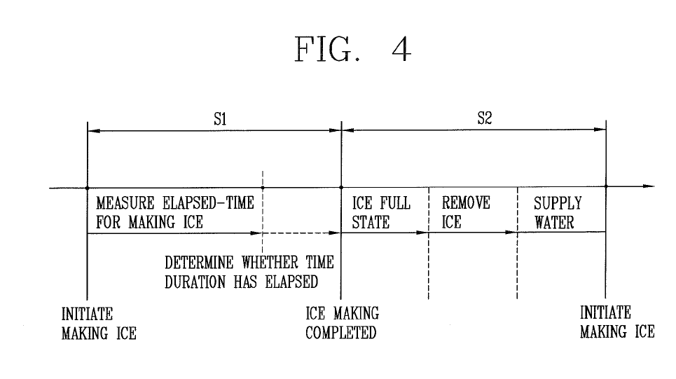

FIGS. 3 and 4 are a flow chart illustrating a power saving method of an ice maker and a time chart according to a first embodiment of the present invention.

A power saving method according to a first embodiment of the present invention is as follows. First, for example, an ice making step is initiated according to whether or not the ice making operation switch 200 is connected or disconnected, at step S100. In detail, when the switch 200 is turned on, initial signal of an ice making operation is transmitted to the controller 600, and thereby, the controller 600 initiates an ice making operation, at step S200. Wherein, the on/off operation of the switch 200 may be performed by the user. When the ice making operation is initiated, power supply to the ice maker 100 is cut off by the controller 600. The cutoff of power supply may be performed by using a breaker (not shown) or the like, connecting the power supply unit 300 and the controller 600. When the power supply is cut off, the elapsed-time which has lapsed up to now starting from the point in time at which the ice making operation was initiated is measured by the timer 400, each time, at step S400. And then, the measured elapsed-time is compared with the reference ice making time, at step S410. In this case, the reference ice making time refers to a minimum time (ts) required for making ice in the ice tray 130. The reference ice making time may be a value obtained through experimentation or a calculation value through a numerical value interpretation such as simulation, or the like. Also, the reference ice making time may be previously set, or may be changed based on the amount of water supply, an internal temperature of the refrigerator, the number of times of opening and closing the door, or the like, rather than being previously set.

Upon comparison, when the elapsed-time (t) measured by the timer 400 is smaller than the reference ice making time (ts), the controller 600 continuously cuts off power supply to the ice maker 100, and repeatedly performs step S400.

Meanwhile, upon comparison, when the elapsed-time (t) measured by the timer 400 is equal to or greater than the reference ice making time (ts), the controller 600 determines that the ice making operation has been completed (step S420) and releases the cutoff of the power supply, at step S500. Namely, the controller 600 releases the cutoff of power supply by using such as a breaker (or the like) and provides control to supply power to the ice maker 100. Accordingly, power is also supplied to the ejector, or the like, of the ice maker 100.

Thereafter, at step S600, it is detected whether or not the ice of the ice tray 130 is in an ice-full state by a detector (not shown) included in the ice maker 100. According to the determination results, at step S610, when the ice of the ice tray 130 is in an ice-full state, the ice is separated from the ice tray 130 by the ejector 110, at step S620. The separated ice is dispensed to and stored in the storage unit 120, and water is supplied again to the ice tray by a water supply device (not shown), at step S700. When it is detected that the ice of the ice tray 130 is not in an ice-full state, since it means that the ice making step has not been completed, power supply to the ice maker 100 is cut off again and the step S400 may be repeatedly performed.

In the first embodiment of the present invention, the ice making step (S1) and steps (i.e., ice-full state detecting, ice removing/dispensing step and water supplying step, S2) other than the ice making step have been described as sequential processes for making ice, and the ice making step may be repeatedly performed in a loop type after the water supplying step.

### Second Embodiment

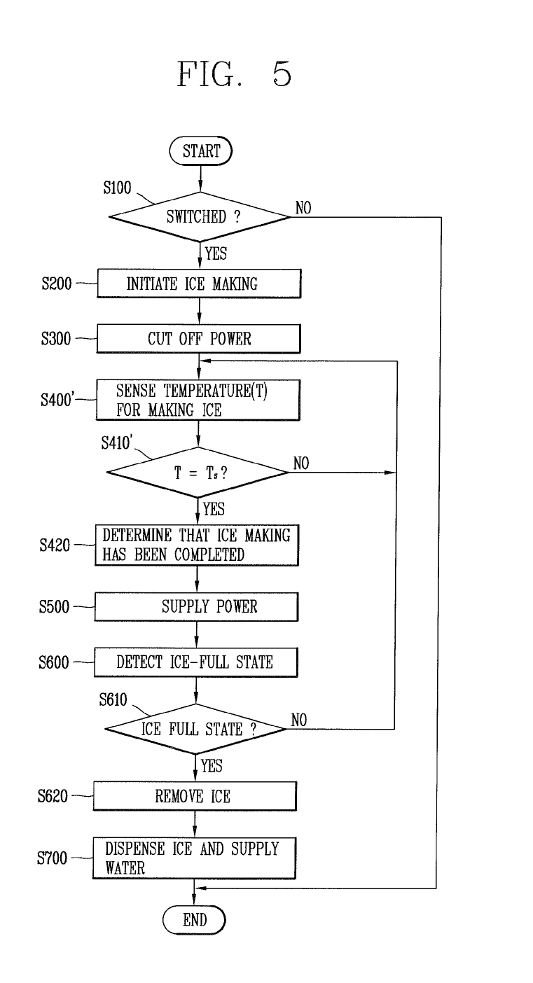

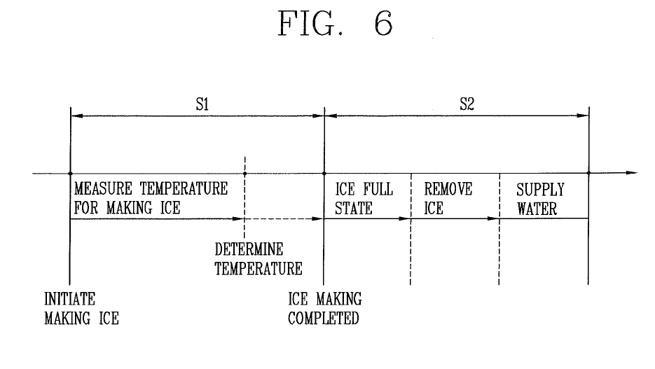

FIGS. 5 and 6 are a flow chart illustrating a power saving method of an ice maker and a time chart according to a second embodiment of the present invention.

A power saving method according to a second embodiment of the present invention is as follows. First, for example, an ice making step is initiated according to whether or not the ice making operation switch 200 is connected or disconnected, at S100. In detail, when the switch 200 is turned on, an initial signal of ice making operation is transmitted to the controller 600, and thereby, the controller 600 initiates an ice making operation, at S200. In this case, the on/off operation of the switch 200 may be performed by the user. When the ice making operation is initiated, power supply to the ice maker 100 is cut off by the controller 600. The cutoff of power supply may be performed by using such as a breaker (not shown) or the like, connecting the power supply unit 300 and the controller 600. When the power supply is cut off, the temperature T of the ice tray 130 is sensed through the temperature sensor unit 500, at step S400′. And then, the sensed temperature is compared with the reference ice making temperature, at step S410′. In this case, the reference ice making temperature refers to the lowest temperature Ts required for making ice in the ice tray 130. The reference ice making temperature may be a value obtained through experimentation or a calculation value through a numerical value interpretation such as simulation, or the like. Also, the reference ice making temperature may be previously set, or may be changed based on the amount of water supply, an internal temperature of the refrigerator, the number of times of opening and closing the door, or the like, rather than being previously set.

Upon comparison, when the temperature T sensed by the temperature sensor unit 500 does not satisfy the reference ice making temperature Ts, the controller 600 continuously cuts off power supply to the ice maker 100, and repeatedly performs step S400′.

Meanwhile, upon comparison, when the temperature T sensed by the temperature sensor unit 500 satisfies the reference ice making temperature Ts, at step S420, the controller 600 determines that the ice making operation has been completed, and releases the cutoff of the power supply, at step S500. Namely, the controller 600 releases the cutoff of power supply by using such as a breaker (or the like) and provides control to supply power to the ice maker 100. Accordingly, power is also supplied to the ejector 110, or the like, including in the ice maker 100.

Thereafter, it is detected whether or not the ice of the ice tray 130 is in an ice-full state by an ice-full state detector (not shown) included in the ice maker 100, at step S600. According to the determination results, at step S610, when the ice of the ice tray 130 is in an ice-full state, the ice is separated from the ice tray 130 by the ejector 110, at step S620. The separated ice is dispensed to and stored in the storage unit 120, and water is supplied again to the ice tray, at step S700. When it is detected that the ice of the ice tray 130 is not in an ice-full state, since it means that the ice making step has not been completed, power supply to the ice maker 100 is cut off again and the step S400 may be repeatedly performed.

In the second embodiment of the present invention, the ice making step S1 and steps (i.e., ice-full state detecting, ice removing/dispensing and water supplying steps, S2) other than the ice making step have been described as sequential processes for making ice, and the ice making step may be repeatedly performed in a loop type after the water supplying step.

### Third Embodiment

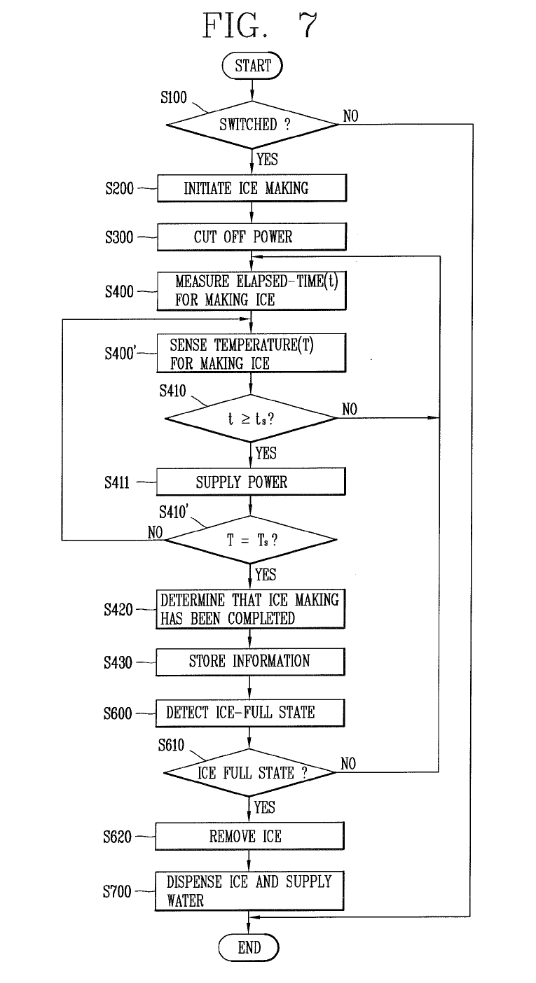

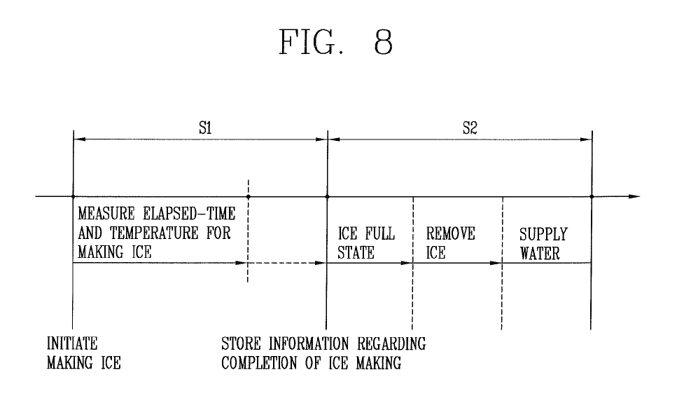

FIGS. 7 and 8 are a flow chart illustrating a power saving method of an ice maker and a time chart according to a third embodiment of the present invention.

According to the third embodiment of the present invention, whether or not an ice making step has been completed can be accurately determined even when the ice making temperature T is not normal (i.e., when it is not equal to the reference ice making temperature) although the reference ice making time is has elapsed).

A power saving method according to a third embodiment of the present invention is as follows. First, for example, an ice making step is initiated according to whether or not the ice making operation switch 200 is connected or disconnected (step S100). In detail, when the switch 200 is turned on, an initial signal of the ice making operation is transmitted to the controller 600, and thereby, the controller 600 initiates an ice making operation, at S200. In this case, the on/off operation of the switch 200 may be performed by the user. When the ice making operation is initiated, power supply to the ice maker 100 is cut off by the controller 600. The cutoff of power supply may be performed by using such as a breaker (not shown) or the like, connecting the power supply unit 300 and the controller 600. When the power supply is cut off, an elapsed-time which has lapsed up to now starting from the point in time at which the ice making operation was initiated is measured by the timer 400, at step S400. And, the temperature T of the ice tray 130 is measured by the temperature sensor unit 500, at step S400′. And then, the measured elapsed-time is compared with the reference ice making time, at step S410. Herein, the reference ice making time refers to a minimum time ts required for making ice in the ice tray 130, and the reference ice making temperature refers to the lowest temperature Ts required for making ice in the ice tray 130. The reference ice making time and the reference ice making temperature may be values obtained through experimentation or calculation values through a numerical value interpretation such as simulation, or the like. Also, the values may be previously set, or may be changed based on the amount of water supply, an internal temperature of the refrigerator, the number of times of opening and closing the door, or the like, rather than being previously set.

Upon comparison, when the elapsed-time t measured by the timer 400 is smaller than the reference ice making time ts, the controller 600 continuously cuts off power supply to the ice maker 100, and repeatedly performs step S400. Upon comparison, when the elapsed-time t measured by the timer 400 is equal to or greater than the reference ice making time ts, the controller 600 compares the sensed temperature with the reference ice making temperature, at S410′. Upon comparison, when the temperature T sensed by the temperature sensor unit 500 does not satisfy the range of the reference ice making temperature Ts, the controller 600 continuously cuts off power supply to the ice maker 100 and repeatedly performs step S400′. Upon comparison, when the temperature T sensed by the temperature sensor unit 500 satisfies the range of the reference ice making temperature Ts, the controller 600 determines that the ice making operation has been completed, at S420. In this case, an array of history information such as the operations before initiating the ice making operation, the initial signal of the ice making operation, elapsed-times measured each time, temperatures sensed each time, the comparison values with the reference ice making time and the reference ice making temperature, and the like, may be stored in the memory 630 or the like, step S430. Also, when a time between the reference ice making time ts and a time at which ice making is actually completed forms a certain error range, the error time range may be stored. For example, when the ice making step is resumed after the water supplying step, the error range stored in the memory may be read to correct or re-set the reference ice making time.

Thus, when it is determined that the ice making operation has been completed, the controller releases the cutoff of the power supply and provides control to supply power again to the ice maker 100. Accordingly, power is also supplied to the ejector, or the like, constituting the ice maker 100.

Thereafter, it is detected whether or not the ice of the ice tray 130 is in an ice-full state by an ice-full state detector (not shown) included in the ice maker 100, at S600. According to the determination results, at step S610, when the ice of the ice tray 130 is in an ice-full state, the ice is separated from the ice tray 130 by the ejector 110 (step S620). The separated ice is dispensed to and stored in the storage unit 120, and water is supplied again to the ice tray by a water supply device (not shown), at step S700. When it is detected that the ice of the ice tray 130 is not in an ice-full state, since it means that the ice making step has not been completed, power supply to the ice maker 100 is cut off again and the step S400 may be repeatedly performed.

In the third embodiment of the present invention, the ice making step S1 and steps (i.e., ice-full state detecting, ice removing/dispensing and water supplying steps, S2) other than the ice making step have been described as sequential processes for making ice, and the ice making step may be repeatedly performed in a loop type after the water supplying step.

As so far described, according to the ice maker for a refrigerator and the power saving method of the ice maker according to embodiments of the present invention, while the ice making operation is being performed, an ice making time and an ice making temperature are measured to determine whether or not the ice making operation has been completed, and power supply to the ice maker is cut off while the ice making operation is being performed, thus reducing unnecessary power consumption.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An ice maker for a refrigerator comprising:
an ice tray configured to make ice;
an ejector configured to remove the ice from the ice tray;
a storage unit configured to store and dispense the removed ice; and
a controller configured to control an ice making operation for making ice, an ice removing operation for removing generated ice, a dispensing operation for dispensing removed ice, and to control power supply to the ice maker including cutting off power supply during the ice making operation.

2. The ice maker of claim 1, further comprising:
a timer configured to measure the elapse of time starting from a point in time at which the ice making operation is initiated; and
a first comparator configured to compare the elapsed-time measured by the timer with a reference ice making time in order to determine whether the ice making operation has been completed.

3. The ice maker of claim 2, further comprising an ice making operation switch configured to generate an initial signal of the ice making operation.

4. The ice maker of claim 2, wherein, when the measured elapsed-time is smaller than the reference ice making time according to the comparison results from the first comparator, the controller is configured to determine that the ice making operation is still being performed and the controller is configured to maintain the cutting off of the power supply, and, when the measured elapsed-time is equal to or greater than the reference ice making time according to the comparison results from the first comparator, the controller is configured to determine that the ice making operation has been completed and the controller is configured to release the cutting off of the power supply.

5. The ice maker of claim 2, further comprising:
a temperature sensor unit configured to sense the temperature of the ice tray while the ice making operation is performed; and
a second comparator configured to compare the temperature sensed by the temperature sensor unit with a reference ice making temperature in order to determine whether the ice making operation has been completed.

6. The ice maker of claim 5, wherein, when the measured elapsed-time is smaller than the reference ice making time according to the comparison results from the first comparator, the controller is configured to determine that the ice making operation is still being performed and the controller is configured to maintain the cutting off of the power supply, and, when the measured elapsed-time is equal to or greater than the reference ice making elapsed-time according to the comparison results from the first comparator and the detected temperature satisfies the reference ice making temperature according to the comparison results from the second comparator, the controller is configured to determine that the ice making operation has been completed and the controller is configured to release the cutting off of the power supply.

7. The ice maker of claim 2, further comprising a memory connected with the controller and configured to store one or more of the measured elapsed-time, an error range with the reference ice making time, the comparison results from the first comparator, and history information regarding the ice making operation, the ice removing operation, and the dispensing operation during a certain period of time.

8. The ice maker of claim 1, further comprising:
a temperature sensor unit configured to sense the temperature of the ice tray while the ice making operation is performed; and
a second comparator configured to compare the temperature sensed by the temperature sensor unit with a reference ice making temperature in order to determine whether the ice making operation has been completed.

9. The ice maker of claim 8, further comprising an ice making operation switch configured to generate an initial signal of the ice making operation.

10. The ice maker of claim 8, wherein, when the measured temperature satisfies the reference ice making temperature according to the comparison results from the second comparator, the controller is configured to determine that the ice making operation has been completed and the controller is configured to release the cutting off of the power supply, and, when the measured temperature does not satisfy the reference ice making temperature according to the comparison results from the second comparator, the controller is configured to determine that the ice making operation is still being performed and the controller is configured to maintain the cutting off of the power supply.

11. The ice maker of claim 8, further comprising a memory connected with the controller and configured to store one or more of the sensed temperature, an error range with the reference ice making temperature, the comparison results from the second comparator, and history information regarding the ice making operation, the ice removing operation, and the dispensing operation during a certain period of time.

12. The ice maker of claim 1, further comprising a display unit configured to display whether the ice making operation is performed.

13. A power saving method of an ice maker for a refrigerator configured to perform an ice making operation for making ice, an ice removing operation for removing generated ice, and a dispensing operation for dispensing removed ice, the method comprising:
determining whether the ice making operation is being performed; and
cutting off power supply to the ice maker when it is determined that the ice making operation is being performed.

14. The method of claim 13, wherein the determining whether the ice making operation is being performed includes:
measuring an elapse of time starting from a point in time at which the ice making operation is initiated;
comparing the measured elapsed-time with a reference ice making time; and
determining whether the ice making operation has been completed according to the comparison results.

15. The method of claim 14, wherein, in determining whether the ice making operation has been completed, when the measured elapsed-time is equal to or greater than the reference ice making time, it is determined that the ice making operation has been completed, and, when the measured elapsed-time is smaller than the reference ice making time, it is determined that the ice making operation is still being performed.

16. The method of claim 14, wherein the determining whether the ice making operation is being performed includes:
sensing a temperature of an ice tray while the ice making operation is being performed;
comparing the sensed temperature with a reference ice making temperature; and
determining whether the ice making operation has been completed according to the comparison results.

17. The method of claim 16, wherein, in determining whether the ice making operation has been completed, when the measured elapsed-time is equal to or greater than the reference ice making time and the sensed temperature satisfies the reference ice making temperature, it is determined that the ice making operation has been completed.

18. The method of claim 14, further comprising storing/recording one or more of the measured elapsed-time, an error range with the reference ice making time, the comparison results in the comparing step, and history information regarding the ice making operation, the ice removing operation, and the dispensing operation during a certain period of time.

19. The method of claim 13, wherein the determining whether the ice making operation is being performed includes:
sensing a temperature of an ice tray while the ice making operation is being performed;
comparing the sensed temperature with a reference ice making temperature; and
determining whether the ice making operation has been completed according to the comparison results.

20. The method of claim 19, wherein, in determining whether the ice making operation has been completed, when the sensed temperature satisfies the reference ice making temperature, it is determined that the ice making operation has been completed, and, when the sensed temperature does not satisfy the reference ice making temperature, it is determined that the ice making operation is still being performed.

21. The method of claim 19, further comprising:
storing/recording one or more the sensed temperature, an error range with the reference ice making temperature, the comparison results in the comparing step, and history information regarding the ice making operation, the ice removing operation, and the dispensing operation during a certain period of time.

22. The method of claim 13, further comprising when it is determined that the ice making operation has been completed, releasing the cutoff of power supply and supplying power to the ice maker.

23. The method of claim 13, further comprising generating a signal in order to inform about an initiation of the ice making operation.
